(19) United States
(12) Patent Application Publication
(10) Pub. No.: US 2021/0311381 A1
(43) Pub. Date: Oct. 7, 2021

(54) BRIGHTNESS AND UNIFORMITY-ENHANCED PROJECTOR SCREEN

(71) Applicant: MirraViz, Inc., Fremont, CA (US)

(72) Inventors: Michael Wang, Sunnyvale, CA (US); Ye Yuan, Fremont, CA (US); Kenneth Hwang, San Francisco, CA (US); Peter M. Baumgart, Pleasanton, CA (US); Stephen Christopher Kekoa Hager, Hayward, CA (US)

(21) Appl. No.: 17/275,633

(22) PCT Filed: Sep. 11, 2019
(86) PCT No.: PCT/US2019/050672

§ 371 Date: Mar. 11, 2021

Related U.S. Application Data
(60) Provisional application No. 62/730,838, filed on Sep. 13, 2018.

(51) Int. Cl. G03B 21/60; G02B 5/124; G02B 5/04; G02B 5/02

(52) U.S. Cl. CPC G03B 21/60; G02B 5/021; G02B 5/04; G02B 5/124

(57) ABSTRACT

The disclosed technology generally relates to displays, and more particularly to projection screens configured to display images with increased brightness and improved contrast and uniformity by using optical layers to control the direction and shape of the return light profiles. The disclosed technology comprises an optical layer configured such that incident light from a light source is directed towards specific positions for all locations on the reflective or transmissive display medium, and a light profile shaping optical layer configured to shape an intensity distribution of light reflected or transmitted from projection screen, prior to displaying the image to a viewer. The direction controlling optical layer and the light profile shaping optical layer may be combined into a single optical medium.

### CROSS-REFERENCE TO RELATED APPLICATIONS

This application claims the benefit of priority to U.S. Provisional Patent Application No. 62/730,838, filed Sep. 13, 2018, entitled “BRIGHTNESS AND UNIFORMITY-ENHANCED PROJECTOR SCREEN,” the content of which is hereby incorporated by reference herein in its entirety.

### INCORPORATION BY REFERENCE

This application incorporates by reference the entirety of U.S. patent application Ser. No. 15/952,148 entitled “RETROREFLECTIVE DISPLAY SYSTEMS CONFIGURED TO DISPLAY IMAGES USING SHAPED LIGHT PROFILE,” filed on Apr. 12, 2018. All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BACKGROUND

### Field

The disclosed technology generally relates to displays, and more particularly to projector display screens configured to improve key viewing parameters such as brightness, uniformity, viewing window and ambient light glare reduction.

### Description of the Related Technology

Current state-of-the-art projector screens have a number of fundamental limitations that inhibit the utility and effectiveness of said screens. The first limitation is that much of the light is reflected (for front-projection systems) or transmitted (for rear-projection systems) to locations where there are no viewers. For front projection screens as an example, the most prevalent screen type is a basic white cloth-based screen which diffuses light broadly in all directions, resulting in a large portion of projected light being reflected to the ceiling and floors or other locations where there are no viewers. The nominal gain values for this class of projector screen is around 0.9 to 1.1 gain where gain is normalized to a value of 1.0 for a calibrated brightness measurement using a white mica block. The second key limitation of conventional white cloth-based projector screens is that contrast ratio is very low. This is because the screen surface is white and scatters light over a broad range of angles which results in a significant amount of ambient light reflecting and scattering to users' eyes which significantly degrades contrast.

There is a class of screens which utilizes ambient light rejecting (ALR) properties to improve contrast ratio performance. These screens reduce the amount of ambient light that is reflected to viewers' eyes thereby improving contrast ratio, however the gain for these types of projector screens is typically low, with values of less than approximately 1.5 for gain at peak locations and often dropping to a gain of less than 1.0 as viewers move away from the projector location.

Currently, there remains a lack of projector screens, that can combine ALR properties with high reflected gain values.

### SUMMARY

In one aspect, a retroreflective (RR) display configured to display an image by retro-reflectively reflecting incident light from a projector comprises a retroreflective (RR) layer comprising a plurality of RR elements arranged laterally across a major surface thereof. The RR display additionally comprises a light profile modulation layer formed over the RR layer. The light profile modulation layer comprises a plurality of light diffusive features arranged laterally across a major surface thereof. The light diffusive features have an average lateral feature size (L). The RR layer and the light profile modulation layer are configured such that a light ray from the projector incident at an incident point on the light profile modulation layer passes therethrough and is retro-reflected by one of the RR elements before exiting at an exit point on the light profile modulation layer. The L is about the same or smaller than a lateral distance between the incident point and the exit point on the light profile modulation layer.

In another aspect, a retroreflective (RR) display configured to display an image by retro-reflectively reflecting incident light from a projector comprises a retroreflective (RR) layer comprising a plurality of RR elements arranged laterally across a major surface thereof. The RR display additionally comprises a light profile modulation layer formed over the RR layer. The light profile modulation layer comprises a plurality of light diffusive features formed across a major surface thereof, wherein the light diffusive features comprise micro-facets. The RR layer and the light profile modulation layer are configured such that light from the projector incident on the light profile modulation layer passes therethrough and is retro-reflected by the RR elements before exiting from the micro-facets of the light profile modulation layer. The micro-facets of at least a subset of the light diffusive features form angles with corresponding micro-facets of immediately adjacent ones of the light diffusive features that are greater than 0.5 degrees along a first lateral axis.

In another aspect, a retroreflective (RR) display configured to display an image by retro-reflectively reflecting incident light from a projector comprises a retroreflective (RR) layer comprising a plurality of RR elements arranged laterally across a major surface thereof. The RR display additionally comprises a light profile modulation layer formed over the RR layer. The light profile modulation layer comprises a plurality of light diffusive features formed across a major surface thereof, wherein the light diffusive features comprise micro-facets. The RR layer and the light profile modulation layer are configured such that light from the projector incident on the light profile modulation layer passes therethrough and is retro-reflected by the RR elements before exiting from the micro-facets of the light profile modulation layer. The micro-facets of at least a subset of the light diffusive features preferentially face a direction that forms an angle greater than 10 degrees relative to one or both of a direction of the light incident on the profile modulation layer and a direction of the light exiting from the profile modulation layer.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings, equations and description are to be regarded as illustrative in nature, and not as restrictive.

### BRIEF DESCRIPTION OF THE DRAWINGS

The novel features of the invention are set forth with particularity. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a schematic illustration of a projector, projecting light onto a conventional projector screen;

FIG. 2A shows a schematic view of a system having a projector and a retro-reflective screen in order to illustrate the basic functionality of screens that utilize retro-reflective optical element with and without additional optical diffuser layers;

FIG. 2B shows example corner cube-type retroreflective elements;

FIG. 2C shows an example bead-type retroreflective elements;

FIG. 3 shows a schematic illustration of bead-based retro-reflective optical elements in isolation as well as comparisons of light paths for prismatic vs bead-based RR elements paired with diffusive optical layers;

FIG. 4 shows a schematic illustration of a bead-based RR optical stack along with example embodiments to improve the desired performance of the optical stack;

FIG. 5 shows a schematic illustration of a screen combining retro-reflective optical elements with engineered optical modulation elements to shape the light beam profile such that the return light beam profile has the desired shape;

FIG. 6A shows an image of a light profile modulation layer having an array of micro-facets as light diffusive features;

FIG. 6A shows a higher magnification image of the light profile modulation layer illustrated in FIG. 6A;

FIG. 7 shows representative light intensity modeling results for double pass micro-facet-based light modulation films paired with retro-reflective optics;

FIG. 8A is a simulation of outgoing light ray angle as a function of incoming facet angle for an example light profile modulation layer arrangement including faceted light diffusive features;

FIG. 8B is a simulation of distribution of light rays as a function of incoming facet angle for the example light profile modulation layer arrangement in FIG. 8A;

FIG. 8C is a simulation of outgoing light ray angles in two dimensions for the example light profile modulation layer arrangement in FIGS. 8A and 8B;

FIG. 9A is a simulation of outgoing light ray angle as a function of incoming facet angle for an example light profile modulation layer arrangement including faceted light diffusive features;

FIG. 9B is a simulation of distribution of light rays as a function of incoming facet angle for the example light profile modulation layer arrangement in FIG. 9A;

FIG. 10 is a simulation of outgoing light ray angles in two dimensions for an example light profile modulation layer arrangement including faceted light diffusive features;

FIG. 11 shows a schematic illustration of front surface Fresnel reflection for a system using retro-reflective optics combined with a light shape modulation layer based on micro-facets;

FIG. 12 shows a schematic illustration of front surface Fresnel reflection for a system using retro-reflective optics combined with a light shape modulation layer based on micro-facets and including the method for optimization of the micro-facets for Fresnel reflection directional control;

FIG. 13 is a schematic side view illustration of how Fresnel reflection can impact a viewer without the embodiment and how the Fresnel reflection impact can be reduced with the embodiment;

FIG. 14 is a schematic illustration of how Fresnel reflection redirection can be used to enhance ambient light rejection;

FIG. 15 is a schematic illustration of different methods for optimization of screens comprising retro-reflective optical layers combined with diffuser or light shaping optical modulation layers;

FIG. 16 schematically illustrates a computer system programmed or otherwise configured to facilitate methods of the present disclosure.

### DETAILED DESCRIPTION OF CERTAIN ILLUSTRATIVE EMBODIMENTS

Reference will now be made to the figures. It will be appreciated that the figures and features therein are not necessarily drawn to scale.

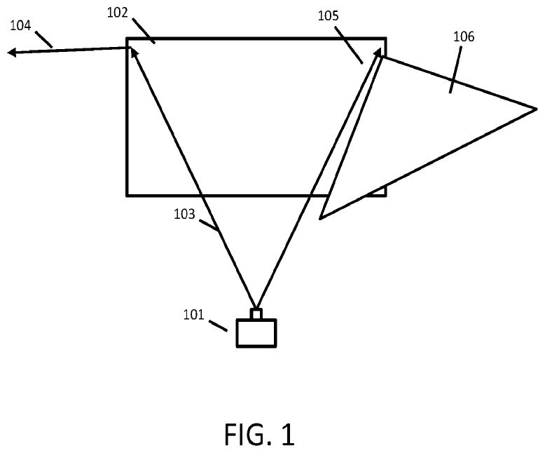

FIG. 1 shows a schematic illustration of a projector 101, projecting light onto a conventional projector screen 102. On the left side of this figure, a beam of light 103 is incident upon the upper left corner of the screen. A reflected beam of light 104 shows schematically the direction of the reflective light if the screen were to have a mirror light surface with no diffusive properties. In this scenario, the direction of beam of light 104 continues toward the left and up and would not be viewable by the majority of viewing locations. On the right another incident beam of light 105 is shown. In this scenario, a highly diffusive reflective surface is assumed, so the resulting reflected light profile is schematically represented by broad triangular shape 106. This broad profile for the reflected light is typical of conventional projection screens and has a benefit in that many viewers are able to see the image on said screen, however, this conventional approach has a major drawback. The drawback is that the highly diffusive surface used in these conventional screens results in very low image brightness and poor image contrast ratio.

To address various needs of existing display technologies described above, the present disclosure provides systems and methods for projector screens that address various limitations of other projector screen systems currently available. The projector screen includes a combination of various media or layers, sometimes including a reflective (RR) medium or a layer and one or more optically functional media or layer(s). As an alternative to conventional display screens, some display systems use an optical layer with retro-reflective (RR) properties combined with a light shape optical modulation layer or diffusive layer to enable a significant brightness increase, as well as ALR capabilities. The pairing of RR optical elements with asymmetric diffuser layers is described in U.S. patent application Ser. No. 15/952,148. This approach has been demonstrated to achieve significant screen gain values as well as a unique MultiView viewing experience. In this application, MultiView refers to a capability wherein individual users are each able to view different content over the entire surface of a single screen at the same time. The MultiView configuration is most suited to scenarios in which the viewers are in close proximity to their respective projector locations. There are a number of scenarios which can benefit from additional solutions to enable more viewers to be able to view content from each projector and to improve the viewing quality for such users. Embodiments disclosed herein provide this and other advantages.

The present disclosure provides systems and methods to engineer and optimize display systems utilizing a projector and a screen. The display systems are optically engineered to optimize the shape or profile and direction of transmitted and reflected light such that the display properties are adapted for a particular purpose or setting.

The term “projector,” as used herein, generally refers to a system or device that is configured to project (or direct) light. The projected light can project an image and/or video.

The term “observation angle,” as used herein, generally refers to an angle between a first line directed from a light source, e.g., a projector, to a given location on a screen and a second line from that same location on the screen to one or more eyes of a viewer.

The term “return angle,” as used herein, generally refers to the angle between an incident beam of light and the reflected beam of light from a screen. For a typical surface, the return angle has a broad range of values. For a retroreflective screen that has not been formed as described herein, the return angle typically has a very small spread of angles centered around zero.

The term “screen incidence angle,” or sometimes referred to as “screen entrance angle” as used herein, generally refers to an angle between a first line directed from a projector to a given location on a screen and a second line that is normal to the nominal front surface of the screen.

The term “MultiView” refers to a capability wherein individual users are each able to view different content over the entire surface of a single screen at the same time, all glasses-free.

The terms “light shaping medium,” “diffuser” “diffusive layer” “light profile modulation layer” or “light shaping optical modulation layer,” which may be used interchangeably, refer to a medium or layer that modulates the angular distribution of light that is transmitted through or reflected from said medium or layer.

The proposed projection screen can have various sizes and configurations. The screen can be substantially flat or curved. The curvature of the screen can be either convex or concave with respect to the viewer. The screen can have a width of at least about 1 meter (m), 10 m, or 50 m, and a height of at least about 0.5 m, 10 m or 50 m. The screen can also have a shape that is not rectangular. The screen can also be non-stationary.

The term “retroreflective” (also “RR”, “retro-reflective” or “retro-reflective” herein), as used herein, generally refers to a device or surface that reflects light back to its source with a minimum scattering of light. In a retroreflective screen, an electromagnetic wave is reflected back along a vector that is parallel to but opposite in direction from the source of the wave. A retroreflective screen comprises a retroreflective surface comprised of many small individual retroreflective (RR) elements.

The term “corner cube reflective element”, as used herein, generally refers to a reflective partial cube composed of three mutually perpendicular, nearly perpendicular, or angled flat reflective surfaces. With this geometry, incident light is reflected back directly towards the source. The configuration of a corner cube reflective element may comprise elements containing only triangular shaped surfaces or may comprise elements containing portions of triangular shaped surfaces or may comprise surface that are polygon in nature in order to maximize the percentage of photons that undergo 3 reflections. The latter type of element is sometimes described as “full-cube” structures. In some cases, the angles between the surface normal vectors for the 3 surfaces comprising each corner cube element are exactly 90 degrees. In other cases, the angles between the 3 surface normal vectors deviate from exactly 90 degrees in order to optimize the retro-reflected light profile as described in U.S. Pat. No. 9,977,320.

Without additional layers or media between the light source and the retro-reflective display medium to significantly change or alter the intrinsic spatial shape or profile, the intrinsic spatial shape or profile is predominantly determined by the retro-reflective elements of the retro-reflective display medium. However, for various applications, it may be desirable to alter the properties, e.g., shape or profile, of the light reflected by the RR medium, or to provide additional content thereto, without or in addition to modifying the retro-reflective elements of the retro-reflective medium.

In various embodiments, the one or more optically functional media can include a light profile shaping medium configured to shape or alter the intensity profile of light passing therethrough. The light profile shaping (also referred to herein as diffuser) medium is configured to be interposed between the retro-reflective display medium and the light source, and to shape an intensity distribution of light reflected from the retro-reflective display medium, prior to displaying the image to a viewer. In some embodiments, the light profile shaping medium is configured to broaden or diffuse the intrinsic intensity distribution along at least one direction parallel to a major surface of the light profile shaping medium.

In various embodiments, the light profile shaping medium is configured to split or multiply the intrinsic intensity distribution into a plurality of distributions along at least one direction parallel to a major surface of the light profile shaping media. In some other embodiments, the light profile shaping medium is configured to broaden or diffuse the intensity distribution and to split the intensity distribution into a plurality of distributions. In still other embodiments, the light profile shaping medium is configured to broaden or diffuse the intensity distribution, while the retro-reflective display medium is configured to split the intensity distribution into a plurality of distributions.

### Retroreflective Displays Including Retroreflective Layer and Light Profile Modulating Layer

In one aspect, a display screen configured to display images using a shaped light profile comprises a retro-reflective display medium configured to display an image by retro-reflectively reflecting incident light from a light source. The display screen additionally comprises a light profile shaping optical medium or layer configured to be interposed between the retro-reflective display medium and the light source, and to shape an intensity distribution of light reflected from the retro-reflective display medium, prior to displaying the image to a viewer. This light shaping medium can also be referred to herein as a “diffuser” or “diffusive layer” or “light shaping optical modulation layer.” The light shaping optical modulation layer is not limited to simple diffusive optical profiles. In a configuration combining a retro-reflective optical layer with a diffuser layer, the incident light from a projector source passes through the diffuser layer, reflects from the retro-reflective optical layer and passes through the diffuser layer once more before reaching the viewers' eyes. The retro-reflective elements in these cases may be prismatic retro-reflective elements or may be bead-based retro-reflective optical elements. The diffuser layer may be a separate layer or may be combined with the retro-reflector layer and form a single optical layer. In a preferred embodiment, the diffuser function should be designed to optimize the distribution of reflected and viewed light to maximize performance of key viewing parameters including, but not limited to brightness, uniformity, contrast ratio, color and ambient light reflection. It is often desirable to have different effective viewing windows in the horizontal versus vertical directions through engineering and design of the diffuser layer. For example, in the horizontal direction there is often a desire to have many viewers watching the same content, so the effective viewing window may be engineered to be +/−10 degrees, 20 degrees, 30 degrees or 50 degrees or more. In the vertical direction the viewing window size may be less in environments where all viewers are sitting or standing and maybe be engineered to be +/−3 degrees, 5 degrees, 8 degrees, 10 degrees or 15 degrees or more. For MultiView applications where it is desirable for individual users to each see different content from their own projector on the same screen, it may be desirable to have narrower viewing windows with vertical viewing in the range of +/−3 degrees, 5 degrees, 8 degrees, 10 degrees or 15 degrees or more and horizontal viewing windows in the range of +/−1 degree or less, 2 degrees, 3 degrees or 5 degrees or more.

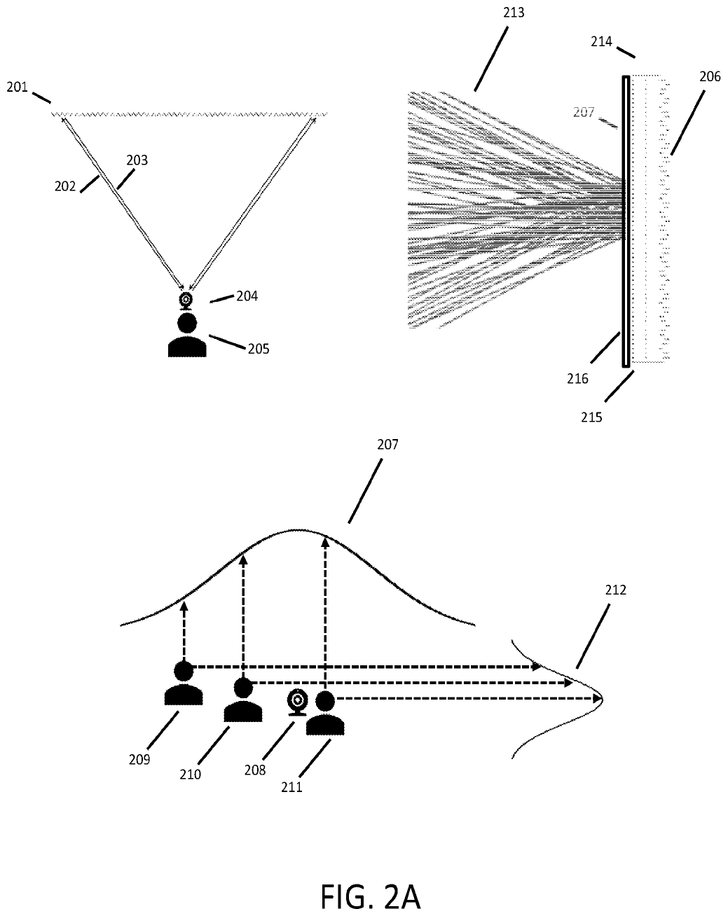

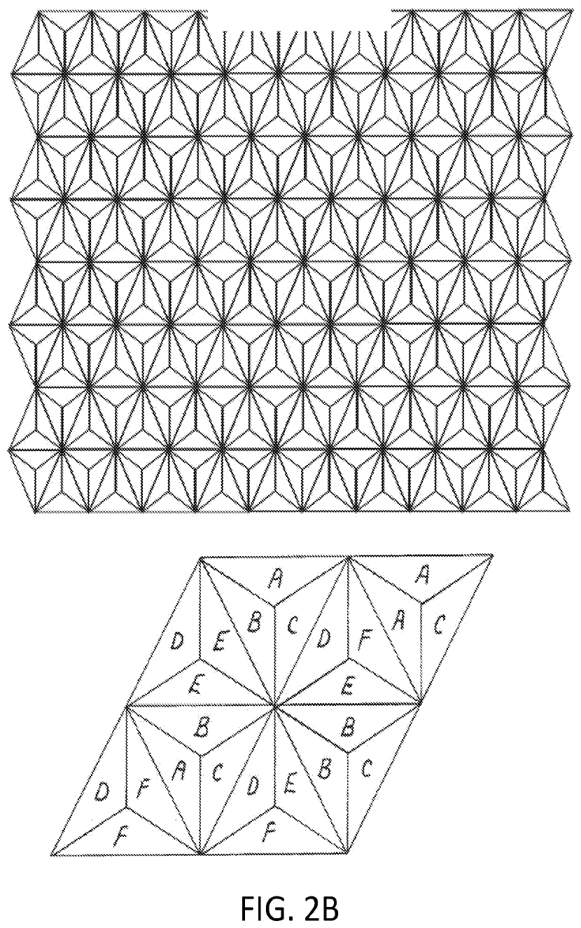

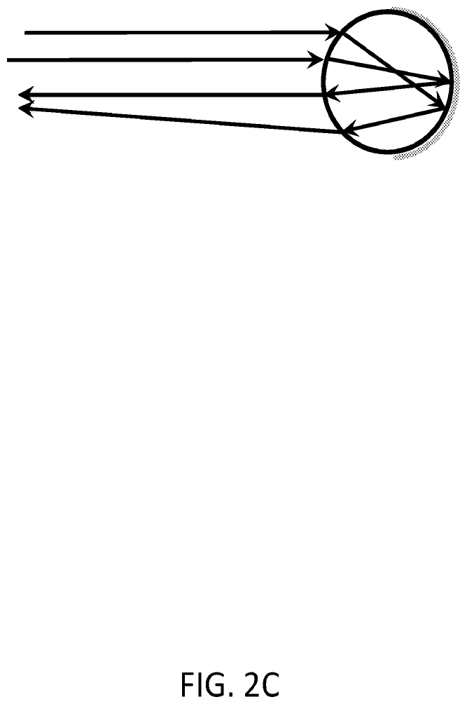

FIG. 2A shows a schematic view of a system having a projector and a retro-reflective screen in order to illustrate the basic functionality of screens that utilize retro-reflective optical element with and without additional optical diffuser layers. The retro-reflective properties of the screen 201 which is comprised of primarily a retro-reflective layer without a diffuser layer results in a majority of the light incident upon the screen 202 to be reflected back towards the projector 204 in a tight directional cone of light 203 regardless of the incident angle. As a result, the viewer 205 need to be in relatively close proximity to the projector 204. The RR elements incorporated in the screen 201 may be prismatic corner-cube-based retro-reflective optical elements or they may be spherical bead-based retro-reflective optical elements. This contrasts with conventional screens which scatter incident light in a relatively isotropic manner. In such a conventional screen set up only a very small fraction of the light incident on the screen impinges upon the viewer's eyes. Because of the retroreflective effect with this type of system, if the viewer 205 is in close proximity to the projector 204 such that the angle defined by the path from the projector to the reflective screen and returning to the viewer's eye is small, then the brightness of the image may be increased significantly over a conventional projector and reflective screen set up. The system of FIG. 2 in some cases does not have a beam splitter. In cases incorporating methods described in U.S. Pat. No. 9,977,320 the viewer and/or the viewer's eye(s) may be at an observation angle that is significantly larger than in scenarios not incorporating these methods. 214 shows an illustrative optical stack combining a retro-reflective optical layer 206 with a diffusive optical layer 215. The two optical layers may be discrete layers abutted together with an air gap, or may be discrete layers bonded together, or may comprise a single optical stack with optics on both front and back sides, or maybe a single optical layer with retro-reflective and diffusive optical functions combined into a single array of optical elements. The outgoing light profile may have a resulting angular spread as illustratively indicated by the multiple rays 213. The optical behavior of this system in scenarios in which the diffusive optical layer 215 is engineered to enable multiple viewers to each see the same content from a single projector is shown at the bottom of FIG. 2A using illustrative intensity curves. 207 shows the horizontal brightness intensity profile and 212 shows the vertical brightness intensity profile. These brightness profiles are indicative of the screen brightness as viewed by different viewers in different locations. The brightness profiles 207 and 212 are not drawn to indicate the intensity of the image at different locations on the screen. In both the horizontal and vertical directions, the peak brightness lines up with the projector location 208. Three representative viewers are shown in this illustration (209, 210 and 211). The relative positions of the viewers are up/down and left/right with all three viewers in the same front/back plane with respective to the projection screen location. The leftmost viewer 209 in this example is therefore taller than the other viewers and to the far left of the projector. Because of the relatively large distance from the projector source in both left/right as well as the up/down directions, viewer 209 will see the lowest brightness intensity on the screen. Viewer 211 is the closest to the projector in both horizontal and vertical directions and as a result will perceive the highest brightness intensity on the display. It is often desirable to have different effective viewing windows in the horizontal versus vertical directions. For example, in the horizontal direction there is often a desire to have many viewers watching the same content, so the effective viewing window may be engineered to be +/−10 degrees, 20 degrees, 30 degrees or 50 degrees or more. In the vertical direction the viewing window size may be less in environments where all viewers are sifting or standing and maybe be engineered to be +/−3 degrees, 5 degrees, 8 degrees, 10 degrees or 15 degrees or more. For MultiView applications where it is desirable for individual users to each see different content from their own projector on the same screen, it may be desirable to have narrower viewing windows with vertical viewing in the range of +/−3 degrees, 5 degrees, 8 degrees, 10 degrees or 15 degrees or more and horizontal viewing windows in the range of +/−1 degree or less, 2 degrees, 3 degrees or 5 degrees or more. Optical stack 214 is drawn with a single diffuser layer 215. In this context, viewing window can be defined by the viewing location and angles at which intensity drops by 50% from peak intensity.

There may be preferred system configurations in which different viewing windows may be selected by the user. A method to achieve this is to add an additional optional diffusive optical modulation layer 216 that can be moved in or out of the front surface of the projector screen. For example, as a possible preferred embodiment, layer 215 might have vertical and horizontal viewing angles of +/−6 degrees and +/−2 degrees respectively. These viewing angles may be well suited to a MultiView application with multiple projects projecting onto a single display. For this same system, layer 216 may be an additional layer that can be added or removed from the system and have vertical and horizontal viewing angles of +/−1-2 degrees and +/−30 degrees respectively. With the stack of 214 and 215, the integrated effective vertical and horizontal viewing angles may be approximately +/−7-8 degrees and +/−30 degrees. These viewing angles may be well suited to a single projector multiple viewer, standard projector viewing application. Therefore, this configuration allows both MultiView and more standard projector screen capabilities to be integrated into a single system.

As described in FIG. 2A, a retro-reflective medium or a retro-reflective screen comprises a plurality of retroreflective (RR) elements. Referring to top of FIG. 2B, in some embodiments, the retro-reflective medium is comprised of an array of truncated corner cube RR elements. The corner cube reflectors may also be comprised of alternative geometries. Examples of corner cube reflectors are provided in U.S. Pat. No. 5,763,049 to Frey et al. and U.S. Pat. No. 7,261,424 to Smith, which patents are entirely incorporated herein by reference. In some embodiments, the size of each of the corner cube reflectors is smaller than the anticipated or predicted pixel size of the projected image, with the pixel size determined by the combination of the projector display system and the distance of the projector from the retroreflective screen.

Referring to bottom of FIG. 2B, a portion of the array of truncated corner cube RR elements with intersecting planes A-F. Planes of adjacent elements may intersect one another at an angle that is 90 degrees. For example, Planes B and C at the bottom left-hand portion of the schematic intersect at an angle of 90 degrees. In some cases, at least one of three intersecting planes can intersect an adjacent plane (e.g., of the same retroreflective screen element) at an angle that is 90 degrees with an offset greater than 0 degrees. For example, the D plane at the bottom left-hand portion of FIG. 2B can intersect the E plane at an angle that is 90 degrees with an offset greater than 0 degrees.

Other implementations of RR elements in retro-reflective medium or retro-reflective screen are possible. In FIG. 2C, an example RR element comprising a bead is illustrated, according to embodiments. In the illustrated implementation, a bead-based RR element is formed of a spherical transparent bead having a metallic coating formed on a portion thereof, such that the bead-based RR element reflects light retro-reflectively.

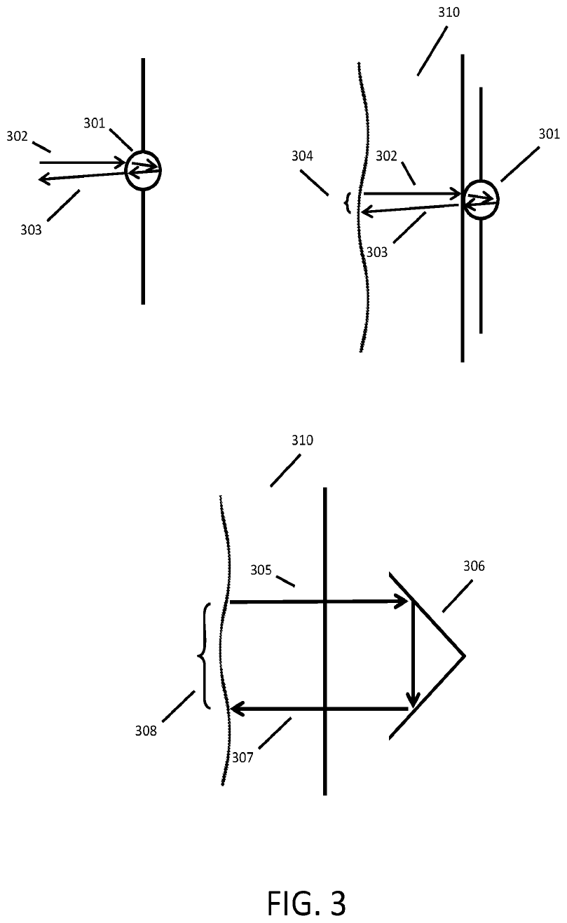

FIG. 3 shows a schematic illustration of bead-based retro-reflective optical elements in isolation as well as comparisons of light paths for prismatic vs bead-based RR elements paired with diffusive optical layers. In FIG. 3, a beam of light 302 is incident upon an illustrative bead-based RR element 301, with a corresponding retro-reflected beam of light 303. When pairing a bead-based RR optical element 301 with a diffusive layer 310, the typical smaller size of the bead-based RR element combined single reflection physics for bead-based retro-reflectors results in a relatively small lateral displacement 304 between incident 302 and reflected 303 beams of light. In contrast, for a similar diffuser 310 combined with a prismatic RR optical element 306, the typical larger size of the prismatic RR element combined with the triple reflection for prismatic element results in a relatively larger lateral displacement 308 between incident 305 and reflected 307 beams of light. This difference is of importance because the functionality of the diffuser layer requires that a significant fraction of the reflected beams of light 303 and 307 pass through a diffusive optical effective angle different from the corresponding incident beam of light 302 and 305. In cases where the reflected beam of light passes through the exact same location on the diffuser as the incident beam of light, then the angle of the reflected beam of light will be unchanged from the incident beam of light and there will effectively be no diffusive effect, since the incoming refractive deflection of the incident beam of light will be offset by the outgoing refractive deflection of the outgoing beam of light.

For illustrative purposes only, the diffuser 310 is illustrated as having rounded protrusions or mounds. However the diffuser 310 can have any suitable shape for optimization of any of light diffusive properties disclosed herein. The suitable shape may include, e.g. a portion of a sphere, an ovoid, a pyramid (e.g. rectangular, triangular), a prism (e.g., rectangular, triangular), a cone, a cube, a cylinder, a plate, a disc, a wire, a rod, a sheet and fractals, to name a few.

### Retroreflective Displays Including Light Profile Modulation Layer Having Dimensionally Optimized Light Diffusive Features

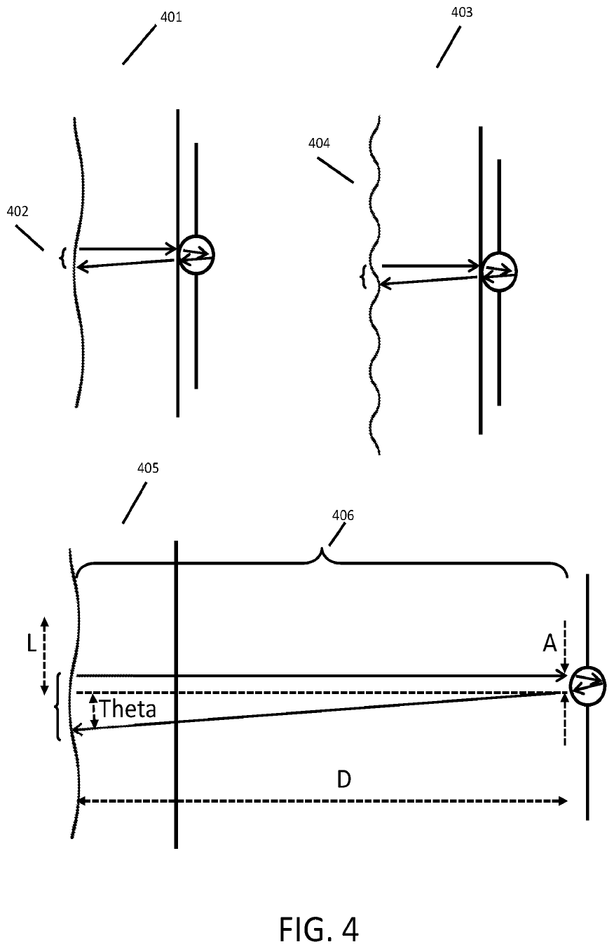

According to various embodiment, a RR display comprises a light profile modulation layer formed over the RR layer and the light profile modulation layer in turn comprises a plurality of light diffusive features arranged laterally across a major surface thereof. The inventors have found that, when the light diffusive features have relatively large average lateral feature size, the light diffusive features may not serve the function of diffusing light adequately. Thus, according to various embodiments disclosed herein, the RR layer and the light profile modulation layer are configured such that a light ray from the projector incident at an incident point on the light profile modulation layer passes therethrough and is retro-reflected by one of the RR elements before exiting at an exit point on the light profile modulation layer. The lateral feature size of the light diffusive features is about the same or smaller than a lateral distance between the incident point and the exit point on the light profile modulation layer. Such arrangement in the context of RR display layers having relatively small RR elements, e.g., bead-based RR elements is described herein with respect to FIG. 4.

In some embodiments, a display screen is configured in a way such that the performance of the diffuser is optimized for bead-based retro-reflectors or smaller prismatic corner-cube based retro-reflectors. In a projection screen configured with a bead-based retro-reflector or small corner-cube retro-reflectors combined with a diffuser layer, there can be cases where the size of the diffuser optical element is relatively large compared to the size of the retro-reflective element. If this occurs, there can be cases in which a beam of light exiting the front side of the optical stack passes through the diffuser at approximately the same location on the same diffuser where that same beam of light was incident to the optical stack. In this case, the diffuser may not function properly as a diffuser since the refraction upon incidence at the diffuser surface may be largely cancelled by an offsetting refraction upon the return path through the same diffuser location. We propose an improved configuration by increasing the lateral spread of light or reducing the diffuser feature size in a manner that ensures proper diffuser functionality. This aspect has relevance to screens using bead-based retro-reflective elements because of the relatively smaller lateral displacement of light upon retro-reflection when compared to the larger lateral displacement when using prismatic-based corner-cube retro-reflectors. Herein, lateral displacement refers to the distance or displacement between the incident and reflected beams of light as measured on the surface plane for the retro-reflective front surface or diffuser front surface.

FIG. 4 shows a schematic illustration of a bead-based RR optical stack along with example embodiments to improve the desired performance of the optical stack. 401 illustratively shows a baseline combined optical stack with 402 illustratively showing that the incident and reflected beams of light are at similar location on the same diffuser shape which results in ineffective diffuser functionality. 403 shows an example of a preferred embodiment. In this example, the diffuser layer 404 is shown with a significantly smaller feature size than for the case in 401. With this smaller diffuser feature size, even though the other optical geometries remain unchanged, the incident and reflected beams of light are at different locations on the diffuser shape which results in proper diffuser functionality for an optical stack with a double pass through a single diffuser layer. 405 shows an example of another preferred embodiment. In this example, the distance 406 between the retro-reflective element and the front surface of the diffuser is increased. With this increase in distance, the incident and reflected beams of light are also at different locations on the diffuser shape, which again results in proper diffuser functionality. The space 406 may be increased through a number of methods including, but not limited to the use of a physical transparent layer such as acrylic, PET or polycarbonate, adding an air gap, or simply increasing the thickness of the diffuser layer. The examples in FIG. 4 are illustrative only. An additional method to optimize the properties of the combined optical stack is to increase the size of the beads used in the retro-reflective layer. Combinations of the above methods with an increase in bead size, combined with a smaller average feature size in the diffusive layer combined with an increased spacing are also proposed embodiments.

Still referring to the illustration at the bottom of FIG. 4, the inventors have found that the following condition can be implemented in some embodiments:

D*sin θ+A≥L [1]

In Eq. [1], A may represent a lateral displacement distance in the surface plane of the RR layer between an incident point on the RR element at which a ray of light is incident and an exit point on the RR element from which the retro-reflected ray of light exits from the RR element. Theta (θ) represents the change in angle between the incident ray of light entering the RR element and the ray of retro-reflected light exiting from the RR element. D represents the distance from a front surface of RR layer to a front surface of the light profile modulation layer or the diffuser layer. L represents the characteristic length scale of the light diffusive element on the light profile modulation layer or the diffuser layer. According to various embodiments, to achieve a desired diffusive function of the diffuser layer, L is about the same or smaller than a lateral distance, which can be approximated by D*sin θ+A, between the incident point and the exit point on the light profile modulation layer or the diffusion layer. According to various embodiments, each of L and A can be about 1 μm-100 μm, 1 μm-70 μm. 1 μm-50 μm, 1 μm-25 μm, or a range defined by any of these values, while satisfying Eq. [1].

Retroreflective Displays with Light Profile Modulation Layer Configured for Light Profile Tailoring Using Micro-Facets of Light Diffusive Features Formed on the Light Profile Modulation Layer

Conventional diffuser layers generally produce Gaussian or normal light distributions. While the characteristics of the Gaussian or normal distribution can be engineered to a limited extent, because Gaussian or normal distributions of light have a peak intensity which falls off from a centroid, viewer may experience a relatively rapid reduction in intensity as he or she moves away from the projector. To mitigate these and other undesirable effects, inventors have found that, by arranging the light profile modulation layer or diffusion layer to have faceted light diffusive elements, and by arranging the facets to have certain non-random orientations, the resulting light profile from the RR display can be engineered to have customized profile that deviates from a normal or Gaussian distribution. Thus, according to various embodiments disclosed herein, the RR display comprises a light profile modulation layer formed over the RR layer, where the light profile modulation layer comprises a plurality of light diffusive features having micro-facets formed across a major surface thereof. In particular, the micro-facets of at least a subset (e.g., 1-20%, 20-40%, 40%-60%, 60-80%, or a range defined by any of these values) of the light diffusive features form angles with corresponding micro-facets of immediately adjacent ones of the light diffusive features that are greater than 0.5 degrees along a first lateral axis. For example, adjacent ones of the light diffusive features comprise corresponding micro-facets form angles relative to the major surface of the light profile modulation layer that are different from each other by at least 0.1 degrees, at least 0.5 degrees, 0.1-5 degrees, 5-10 degrees, 10-15 degrees, 15-20 degrees, 20-25 degrees, 25-30 degrees, 30-35 degrees, 35-40 degrees, 40 to 45 degrees, or an angle in a range defined by any of these values, along one or both of orthogonal lateral axes (e.g., x and y axis) in some arrangements, while in other arrangements, the adjacent ones of the light diffusive features comprise corresponding micro-facets form angles relative to the major surface of the light profile modulation layer that are different from each other by at least 0.5 degrees, e.g., between 0.5 and 10 degrees, along one (one of x and y axes) of the orthogonal axis but not along the other of the orthogonal lateral axes (e.g., the other of x and y axes). In the other of the orthogonal lateral axes, the adjacent ones of the micro-facets form angles relative to the major surface of the light profile modulation layer may be substantially the same (e.g., less than 0.5 degrees).

Thus, aspects of the disclosed technology include a display system that uses engineered micro-facets paired with a retro-reflective optical layer. With an array of precisely oriented facets (such as squares or hexagons or triangles), there are a number of key advantages conferred beyond what is normally achievable with “hill” or “wave” shaped diffusive surfaces. One key advantage is that the resulting light profile can be configured to have shapes different from a typical Gaussian-like distribution. For example, a plateau shape or a double hump shape can be achieved. In addition, sharper diffusive cutoffs can be achieved, which increases the amount of light available for desired angles where viewers are most likely to be located. Detailed of implementation are outlined in the Figure descriptions below.

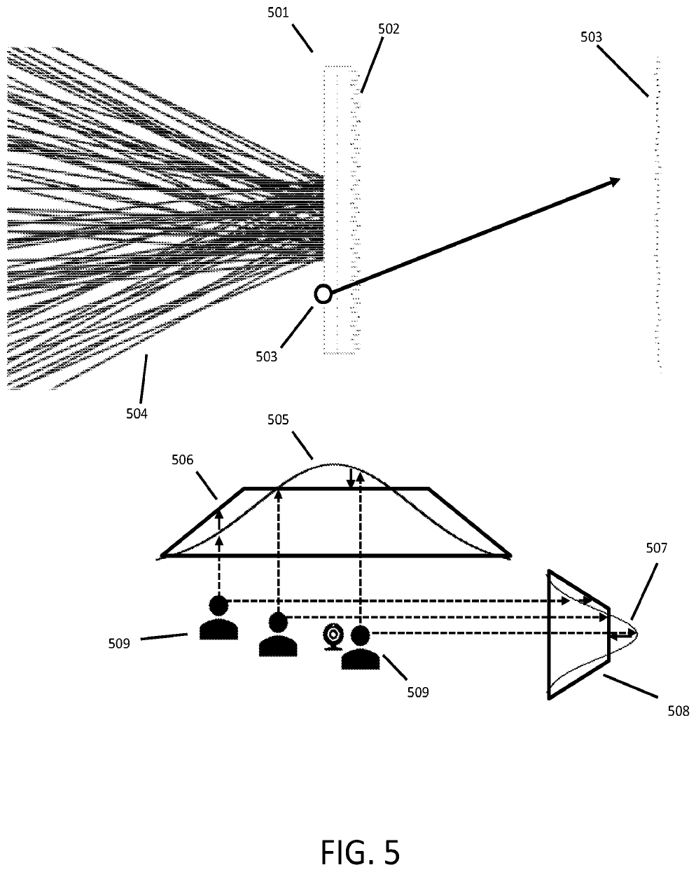

FIG. 5 shows a schematic illustration of a screen combining retro-reflective optical elements 502 with engineered optical modulation elements 503 (shown both on the left in the stack, and at a higher magnification to the right) to shape the light beam profile such that the return light beam profile 504 has the desired shape and properties. The RR elements 502 are illustratively shown with triangles in this particular figure which can indicate corner-cube-based RR elements. However, embodiments are not so limited. For example, the optical stack 501 describe herein can also be made using bead-based RR elements. The optical modulation elements 503 are shown as an array of micro-facets where each micro facet has an angle that results in refraction of incoming and outgoing light. The term micro-facet is used herein to describe discrete optical elements where the orientation and properties of each of the optical elements is be engineered to have a relatively flat surface with a specific angle of orientation that may be different from neighboring optical elements. The micro-facet shape choices may include, but not limited square, triangular, hexagonal or parallelogram shapes. The micro-facets may have a smooth surface or an intentionally roughened surface. The micro-facets may be completely flat or may include slight curvatures. The benefits of using a micro-facet array according to embodiments over more conventional “hill” or “wave” shape structures that are often used for diffuser films includes, among other benefits, the characteristic that the shape of the light profile can be better optimized to meet system requirements. 505 and 507 schematically show representative horizontal and vertical light profiles, respectively, that would result from a conventional diffuser layer. 506 and 508 schematically show representative horizontal and vertical light profiles, respectively, that can be obtained from a micro-faceted-based light modulation film. FIG. 5 shows how the light intensity profile can be made more uniform such that different viewers will see more similar brightness level, and the system can avoid delivery images that are either too bright or too dim. For example, with a traditional diffuser, the viewer on the far left 509 might be observing a brightness level 4-5x lower than the viewer closest to the projector source 510. The viewer closest to the projector source may be observing a brightness level high enough to be too bright for nominal comfortable viewing. With the preferred embodiment, and the brightness profiles shown with 506 and 508, the locations with brightest intensities are reduced, while the locations with low brightness intensities are in many cases increased. It will be appreciated that the trapezoidal shape of the light profiles 506, 508 shown in FIG. 5 is for illustrative purposes only, and that the light profiles 506, 508 can be engineered to have light profile shapes. For example, it may be desirable in many applications to minimize the amount of light that returns directly back to the projector, since viewers will not be able to position themselves in that location due to the physical space limitation imposed by the projector itself. The allocation of photons that would have gone to this angle of reflection could then be allocated to other angles for overall increased system efficiency and brightness. The micro-facet size needs to be small relative to the projected image pixel size in order to achieve a distribution of different micro-facet orientations for each pixel. For example, at 4K resolution, the display is 3840 pixels×2160 pixels. Therefore, for a 4K projector with a screen of 2 meters (2000 mm) in width, each pixel will be 521 um×521 um in size (2000 mm/3840 pixels=0.521 mm). Depending on the size of the screen and the projector resolution, the micro-facet size can be about 1 um, 3 um, 5 um, 10 um, 15 um, 25 um, or 50 um or 100 um, or a size having a value in range defined by any two of these values. The ratio of the pixel area to the micro-facet size area can be about 25:1 or 100:1, or 2500:1 or 10,000:1 or 100,000:1 or more, or a ratio having a value in a range defined by any two of these values. As an example, the resulting average number of facets-per-pixel for a micro-facet size of 10 um is 2601 (521 um/10 um*521/10 um=2601). A large number of facets per pixel helps to ensure good uniformity and visual quality. The range of angles for the micro-facet orientations can depend on the specific application. It is often desirable to have different effective viewing windows in the horizontal versus vertical directions. For example, in the horizontal direction there is often a desire to have many viewers watching the same content, so the effective viewing window may be engineered to be +/−10 degrees, 20 degrees, 30 degrees, or 50 degrees or more, or a value in a range defied by any two of these values. In the vertical direction the viewing window size may be less in environments where all viewers are sitting or standing and maybe be engineered to be +/−3 degrees, 5 degrees, 8 degrees, 10 degrees or 15 degrees or more, or a value in a range defined by any two of these values. For MultiView applications where it is desirable for individual users to each see different content from their own projector on the same screen, it may be desirable to have vertical viewing windows in the range of +/−3 degrees, 5 degrees, 8 degrees, 10 degrees or 15 degrees or more, or a value in a range defined by any two of these values, and very small horizontal viewing windows in the range of +/−1 degree or less, 2 degrees, 3 degrees or 5 degrees or more, or a value in a range defined by any two of these values. For a given desired viewing window, the range and distribution of actual micro-facet angles can be determined through a variety of optical simulation methods.

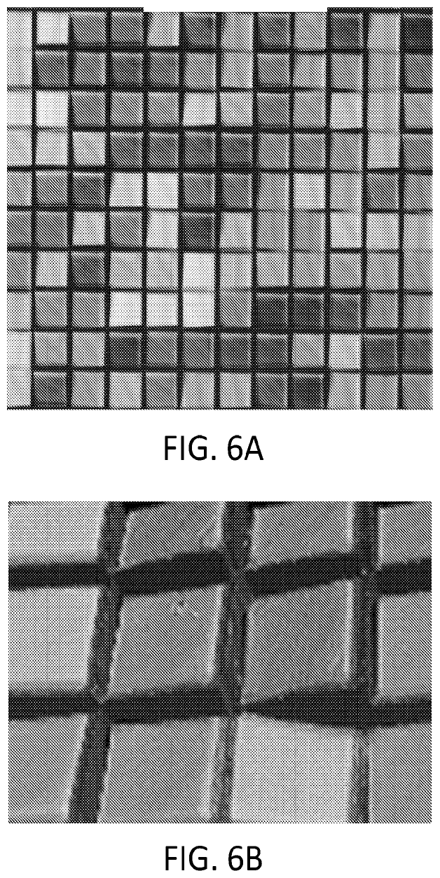

FIG. 6A shows an image of a light profile modulation layer having an array of micro-facets as light diffusive features describe above with respect to FIG. 5. FIG. 6A shows a higher magnification image of the light profile modulation layer illustrated in FIG. 6A. In the illustrated example, the micro-facets are generally rectangular.

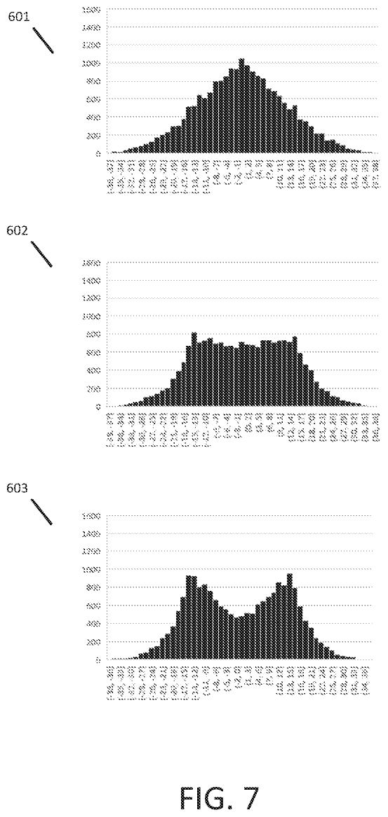

FIG. 7 shows representative light intensity distribution modeling results for double pass micro-facet-based light modulation films paired with retro-reflective optics. Each of the charts 601, 602 and 603 show a different scenario plotting outgoing light profile based on ray tracing of 20,000 light rays. Each light ray is propagated through a micro-faceted-based light modulation layer, reflected from a retro-reflective optical element and propagated back through the micro-faceted-based light modulation layer. The index of refraction used in the modeling was in the range of 1.45. In all 3 scenarios, there is the same overall distribution of angular orientations is used for the micro-facets. The horizontal axis in each chart shows the angle of the outgoing reflected light rays in degrees. The vertical axis shows the number of light rays with outgoing reflected light rays at the different angles. For the chart shown in 601, the micro-facets are randomly distributed between −30 degrees and +30 degrees relative to the plane of the screen surface, with no exclusion rules. In analyzing the peak shape, the peak location at small angles on the horizontal axis are comprised of specific cases in which the incident beam of light passes through a micro-facet with the same angular orientation as the outgoing beam of light. The chart 602 shows the angular intensity profile resulting from another preferred embodiment in which an exclusion rule applied to reduce the frequency for adjacent micro-facets to have largely similar angular orientations. With this rule applied, it can be seen that the resulting light intensity angular distribution can be significantly flattened similar to the desirable profile shown in FIG. 5 in schematic form 506. The chart shown in 603 shows yet another angular intensity profile wherein the exclusion rule that reduces the frequency for adjacent micro-facets is further strengthened. In this case, it can be seen that the intensity at very low angles corresponding to the projector location can be reduced in order to increase the light intensity at slightly larger angles where viewers will be more likely to be present. The micro-facets for this purpose can be curved or roughened or otherwise not completely flat. Another aspect of this disclosure is optimization of the size of the micro-facet in order to achieve optimal system performance. The length scale of the micro-facets should be significantly smaller than the image pixel size and should be comparable or smaller than the typical lateral distance between incident and reflected locations for the beam of light entering and exiting the retro-reflective optical elements in the projection screen. As an illustrative example with a cube-corner based retro-reflective optical element with prism bases lengths on the order of 150 microns, it may be beneficial to have the micro-facet size be on the order of less than 50 microns, or less than 30 microns or less than 20 microns or less than 10 microns or less than 5 microns, or a value in a range defined by any two of these values, in lateral dimension.

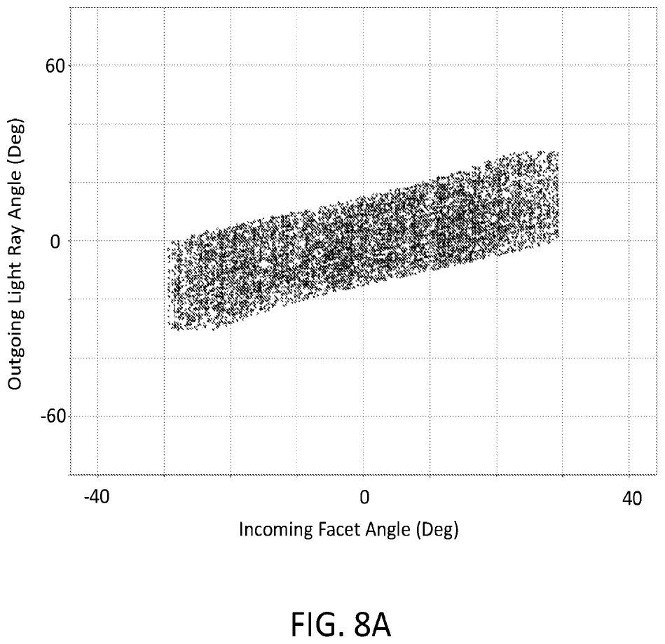

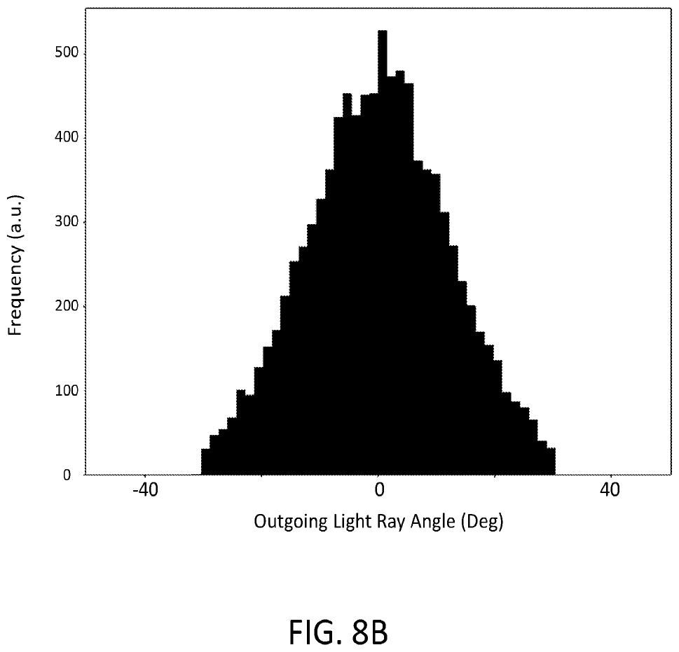

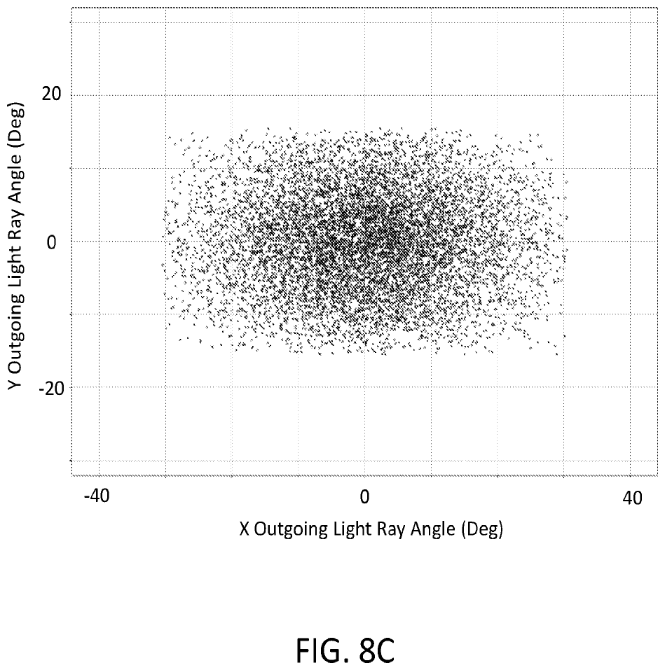

Further modeling results of customization of light distribution shape and profile with faceted diffuser design combined with reflective back optics are illustrated with reference to FIGS. 8A-10. The basic structure modeled is a front diffuser comprised of an array of facets formed over a retroreflective layer. The front facets will refract light at the air/material interface when the light ray passes from air to the optical layer and after the reflection when the light ray passes from the optical layer to air (see also FIG. 4). As described hereinbelow, a facet angle refers to an angle between the vector normal to the facet surface and the vector normal to the display surface. An incoming ray facet angle refers to the facet angle of the facet that the incoming ray intercepts. An outgoing ray facet angle refers to the facet angle of the facet that the outgoing ray intercepts.

FIG. 8A shows a representative simulated plot of outgoing ray angle (y-axis) plotted against the facet angle of the light diffusive features of the diffuser for the incoming light ray (x-axis). In this plot, for a given incoming ray facet angle, the outgoing light ray angle (y-axis value) will span a range determined by the facet angle intercepted by the light ray when it exits the structure after reflection. When the outgoing facet angle is matched to the incoming facet angle, the outgoing ray angle will be zero degrees.

FIG. 8B shows a distribution of outgoing ray angles. The illustrated plot is a distribution plot of the x-y plot shown in FIG. 8A where the distribution of facet angles is selected to be uniform and random. The key point to make here is that despite an evenly distributed set of facet angles which may result in a plateau shaped single pass distribution of transmitted light, after a double pass through the same structure, the resulting profile is very “Gaussian-like” in shape.

FIG. 8C shows the simulation results described above with respect to FIGS. 8A and 8B plotted as a two-dimensional scatter plot of outgoing light ray angle with respect to a first lateral axis, e.g., x-axis (x-axis) versus outgoing light angle with respect to a second lateral axis, e.g., y-axis (y-axis). The scatter plot shows that the light profile is peaked near the center of region. In many cases for display applications, this may be an undesirable profile. A flatter profile with more plateau-like shape may be preferred for relatively constant light intensity experienced by the viewer.

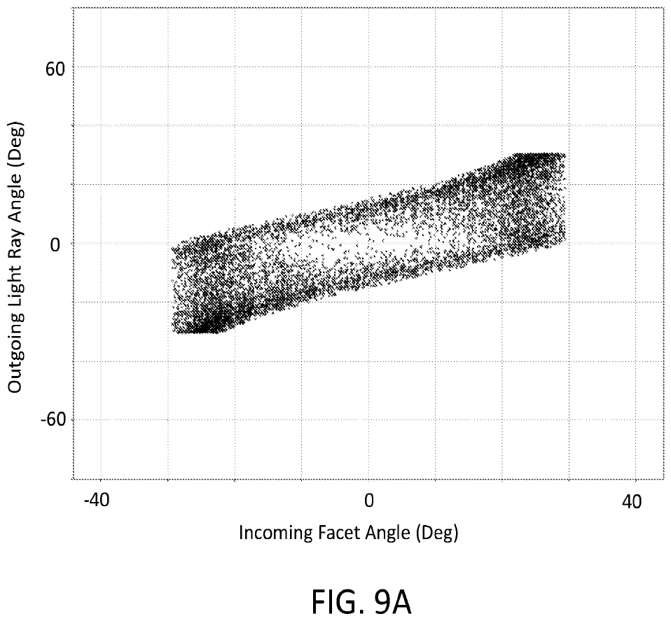

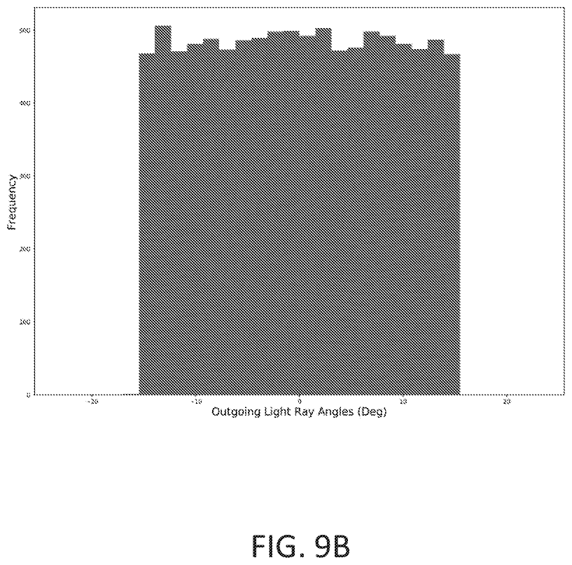

FIG. 9A shows a representative plot of outgoing ray angle (y-axis) plotted against the facet angle for the incoming light ray (x-axis), for a diffuser layer according to embodiments. In this case, algorithms are applied in the facet design to disallow certain cases in order to achieve a flatter, more plateau-like shape. Some representative algorithm approaches to arrive at desired light profiles are discussed below for a better understanding of the methodologies used herein.

For the first algorithm, if the desired result is to eliminate the tail regions in FIG. 8B, conditions for nearest neighbor facets can be applied such that when the incoming facet angle is on the more extreme negative end of the distribution, then adjacent facets which are most likely to intercept the outgoing ray of light a not allowed to be on the more extreme positive end of the distribution. Similar criteria can be applied to the corresponding positive end of the distribution for incoming facets angles and disallow nearby facets from having too negative of a facet angle that may be intercepted by outgoing light rays. This set of conditions will effectively cut-off the tail ends of the distributions shown in FIGS. 8A and 8B.

Another criteria that can be applied is to reduce the occurrence rate for combinations of incoming and outgoing facet angles that result in an outgoing ray angle near zero. By applying this type of criteria, the inner portion of the distribution in FIG. 8A can be reduced, resulting in a profile more like shown in FIG. 9A. By implementing both a tail trim algorithms as well as center peak reduction, the resulting outgoing light distribution can be as shown in FIG. 9B. A flat plateau shaped profile as shown in FIG. 9B is not attainable with a traditional diffuser in which the input and output angles are not controllable or engineered.

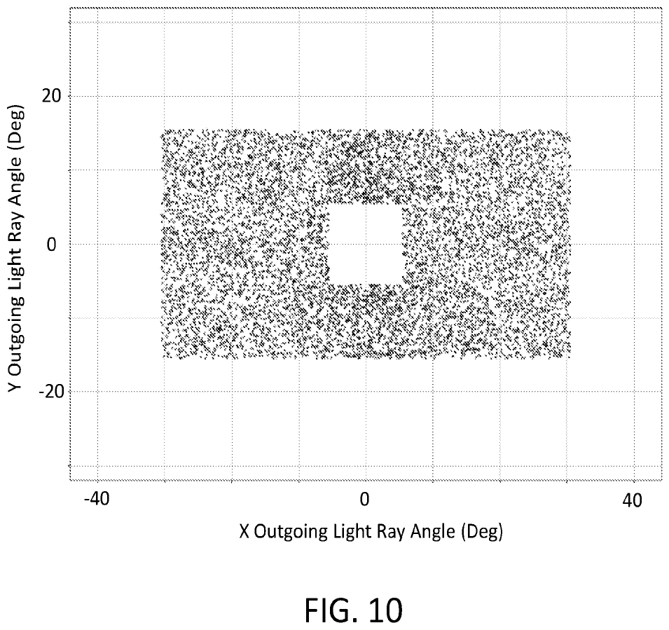

A third example of methods to optimize the light profile is to entirely “carve-out” or eliminate certain regions of the light profile. For example if the reflective layer in the overall optical stack is retroreflective in nature, the light profile shape is centered on the projector location. Viewers tend to not be in the immediate proximity of the projector due to physical space constraints and noise issues, so it is sometimes desirable to not send light directly back to the projector source. By applying filtering criteria in two dimensions, the resulting light profile can be engineered to even include carve-out center regions as shown in FIG. 10. The resulting representative profile shown in FIG. 10 is unique for its flatness, sharp edge cutoff and carve-out regions. All or combinations of these types of algorithms may be used to optimize the light profile shape for a given application.

In general there are multiple ways to implement above algorithms. One representative way is to set conditions and disallow violations while randomly selecting facet angles. Once the multi-criteria conditions pass, no further forcing function is applied. Another potential method to implement is to force not only the criteria, but also the distribution for the cases that pass the criteria. Example flow may include the steps of (1) randomly selecting an outgoing facet angle (2) calculating outgoing ray angle for adjacent facets (that are the highest likelihood to have intercepting the incoming ray of light). (3) If the outgoing ray angle is in the tail region or if the outgoing ray angle is populating a region that is overpopulated, repeat random section of outgoing facet angle.

Retroreflective Displays with Light Profile Modulation Layer Configured for Light Profile Tailoring to Reduce Noise Using Preferentially Facing Micro-Facets of Light Diffusive Features Formed on the Light Profile Modulation Layer

One of the factors that reduces contrast and efficiency of RR displays is unintended light, e.g., ambient light. The inventors have found that the light diffusive features of a light profile modulation layer can be tailored to reduce background noise (e.g., ambient light, stray light or any other light that is unintentionally reflected into viewer's eyes). For example, in light profile modulation layers that include faceted light diffusive features, the inventors have found that, by arranging a subset of the diffusive features to have a preferential alignment of the facets, the effects of ambient light, which partly results from Fresnel reflection, can be significantly reduced.

To address these and other needs, in another aspect, a retroreflective (RR) display configured to display an image by retro-reflectively reflecting incident light from a projector comprises a retroreflective (RR) layer comprising a plurality of RR elements arranged laterally across a major surface thereof. The RR display additionally comprises a light profile modulation layer formed over the RR layer. The light profile modulation layer comprises a plurality of light diffusive features formed across a major surface thereof, wherein the light diffusive features comprise micro-facets. The RR layer and the light profile modulation layer are configured such that light from the projector incident on the light profile modulation layer passes therethrough and is retro-reflected by the RR elements before exiting from the micro-facets of the light profile modulation layer. The micro-facets of at least a subset (e.g., 1-20%, 20-40%, 40%-60%, 60-80%, or a range defined by any of these values) of the light diffusive features preferentially face a direction that forms an angle greater than 10 degrees relative to one or both of a direction of the light incident on the profile modulation layer and a direction of the light exiting from the profile modulation layer.

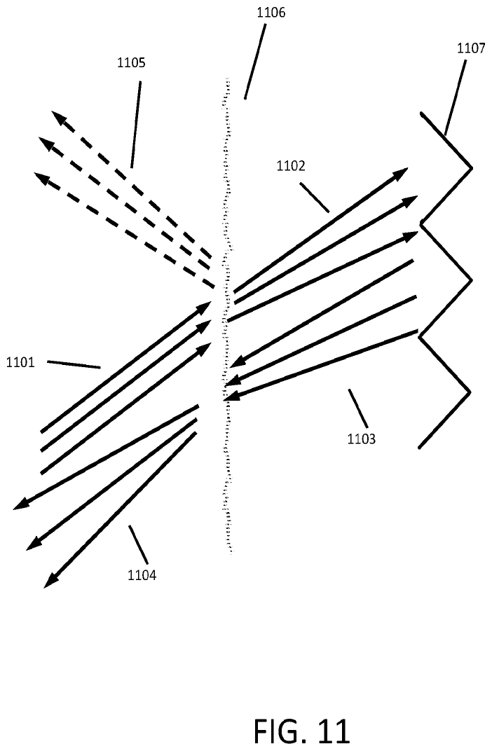

FIG. 11 shows a schematic illustration of front surface Fresnel reflection for a system using retro-reflective optics combined with a light shape modulation layer 1106 based on micro-facets. In the illustrated embodiment, the incident light 1101 passes through the light shape modulation layer and the resulting beams of light 1102 have an increased spread due to the light shape modulation function. The light is then reflected from the RR layer 1107 and those light beams 1103 pass through the light shape modulation layer a second time. The resulting outgoing light 1104 has the desired spread as engineered per the specific application. In addition to these rays of light there is also a component of light that undergoes what is referred to as front surface Fresnel reflection. These beams of light are labeled 1105 and are drawn with dashed lines. The intensity of the light is on the order of approximately 4% of the intensity of the incident beam of light as determined by the Fresnel equations. In many applications, it is desirable to either reduce or control the direction of this Fresnel reflection. Anti-reflection schemes have been used to reduce the amount of Fresnel reflection. However, these anti-reflection coating can be expensive and difficult to integrate with optics that may already be present on the front surface of the screen. An alternative approach is to control the direction of the Fresnel reflection with the usage of micro-facets in the light shape modulation layer, according to embodiments. In traditional films, this is difficult to achieve because the average orientation of the front surface is parallel to the plane of the front surface, so the resulting direction of the Fresnel reflection is set by the orientation of the overall planar front surface of the screen. The light shape modulation layer 1106 in this figure is drawn to schematically indicate the use of micro-facets, however it is not drawn with incorporation of the proposed methods for improvement. This can be schematically seen by the manner in which the average of the facet orientations is approximately parallel to the orientation of the screen front surface.

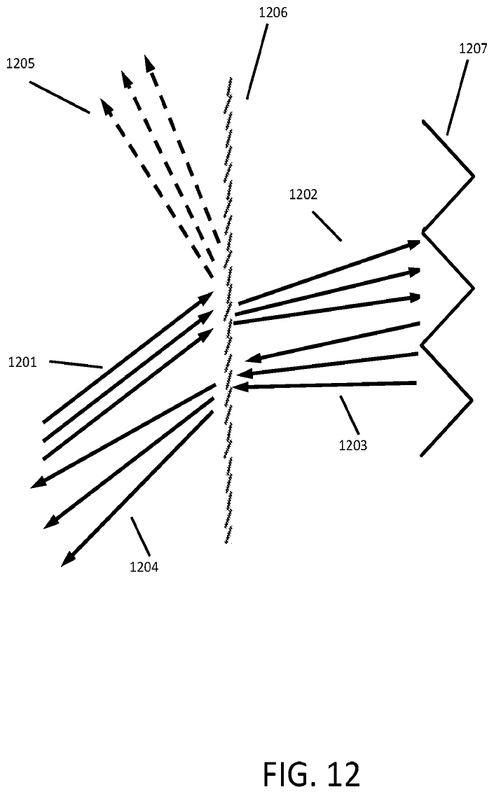

FIG. 12 shows a schematic illustration of front surface Fresnel reflection for a system using retro-reflective optics combined with a light shape modulation layer 1206 based on micro-facets and including the method for optimization of the micro-facets for Fresnel reflection directional control. In this Figure, the array of micro-facets 1206 have an average orientation that is not parallel to the orientation of the screen front surface. It can be qualitatively observed that the orientation of the facets on average is rotated clockwise in the field of view. In this Figure, the incident light 1201 passes through the light shape modulation layer and the resulting beams of light 1202 have an increased spread due to the light shape modulation function. In addition, compared to FIG. 11 and 1102, the beams of light 1202 have additional average deflection due to the increase amount of refraction due to the average rotation of orientation of the micro-facets 1206. The light is then reflected from the RR layer 1207 and passes through the light shape modulation layer a second time. The resulting outgoing light 1204 experiences an increased amount of refraction, again due to the orientation of the micro-facets. The average amount of increased refraction offsets the added refraction experienced for the incident beams of light. As a result, the outgoing light 1204 not only has desired spread as engineered per the specific application, but also has a relatively unchanged direction of reflection as compared to the outgoing light 1104 in FIG. 11, despite the change in average orientation of the micro-facets. In addition to these above-mentioned rays of light there is also a component of light that undergoes front surface Fresnel reflection. These beams of light are labeled 1205 and are drawn with dashed lines. As a result of the micro-facet average orientation, the light that undergoes Fresnel reflection 1205 has a different angle of reflection compared to the comparable light rays 1105 shown in FIG. 11. The ability to control the direction of Fresnel reflection without significantly impacting the retro-reflective nature of the combined optical stack can be of use for MultiView screen applications in which the Fresnel reflection is one of the more significant components of reflection responsible for cross-talk. For reference, cross-talk in this context refers a viewer being able to observe content coming from adjacent projectors that are not projecting the viewer's desired content. If the Fresnel reflection can be engineered to point in a direction such that the viewers do not see the reflection, then overall system performance can be significantly improved.

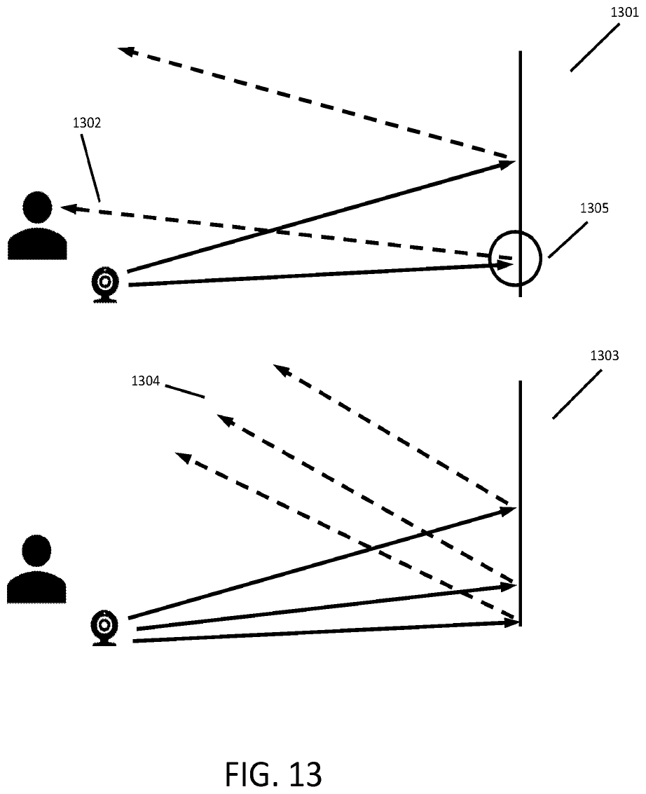

FIG. 13 is a schematic side view illustration of how Fresnel reflection can impact a viewer without the embodiment and how the Fresnel reflection impact can be reduced with the embodiment. 1301 shows a scenario without the preferred embodiment. In this scenario, there is typically a location on the screen in which the Fresnel reflected component of light 1302, is angled in a direction that reaches the primary viewer. 1303 shows a scenario with the preferred embodiment. In this scenario, there is no location on the screen in which the Fresnel reflections 1304, are angled in a direction that can reach the primary viewer.

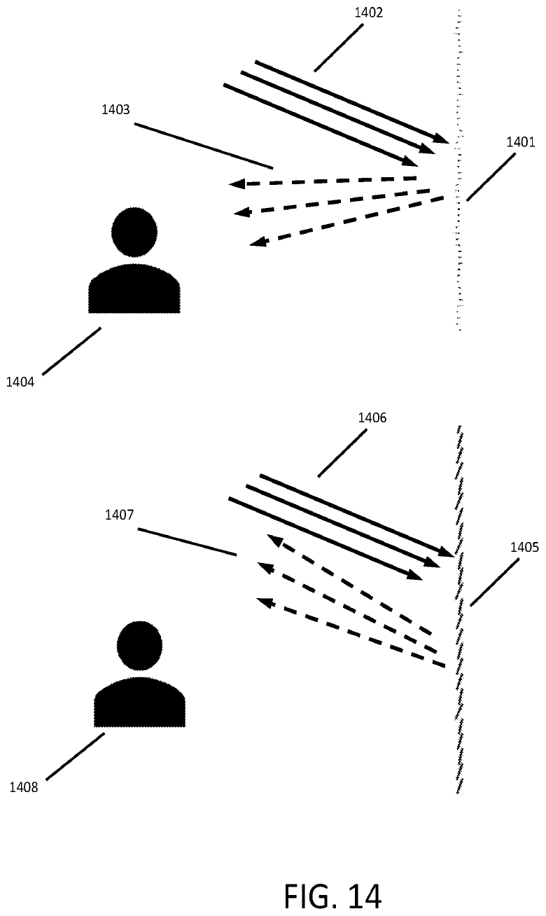

FIG. 14 is a schematic illustration of how Fresnel reflection redirection can be used to enhance ambient light rejection. 1401 shows a screen using a front side micro-facet array that does not incorporate the proposed method for improvement. 1402 is an illustrative incoming set of light rays originating from ambient overhead lighting or outdoor lighting as examples. 1403 indicates the reflected light rays from the front surface of the screen of which a significant portion of the light may be directed towards the viewer 1404. If enough ambient light is directed to the viewer, overall image quality and user experience can suffer. 1405 shows a screen using a front side micro-facet array that does incorporate the proposed method for improvement. It can be qualitatively observed that the orientation of the facets on average is rotated clockwise in the field of view. 1406 is an illustrative incoming set of light rays originating from ambient overhead lighting or outdoor lighting as examples. 1407 indicates the reflected light rays from the front surface of the screen of which a significant portion of the light is directed away from the viewer 1408. This ability to minimize glare and reflection from ambient light can significantly enhance the user viewing experience. It should be noted that for simplicity, 1401 and 1405 are drawn without showing the retro-reflective component. For the decoupling of the light shaping properties from the Fresnel reflection re-direction functions, it is ideal that the light passes through the light shaping films (comprised of the micro-facets) two times. The first pass is incident beam and the second pass is after retro-reflection with the outgoing beam of light. With the double pass, the functionality of the light shaping layer will be preserved and can be independently engineered separately from the Fresnel redirection function.

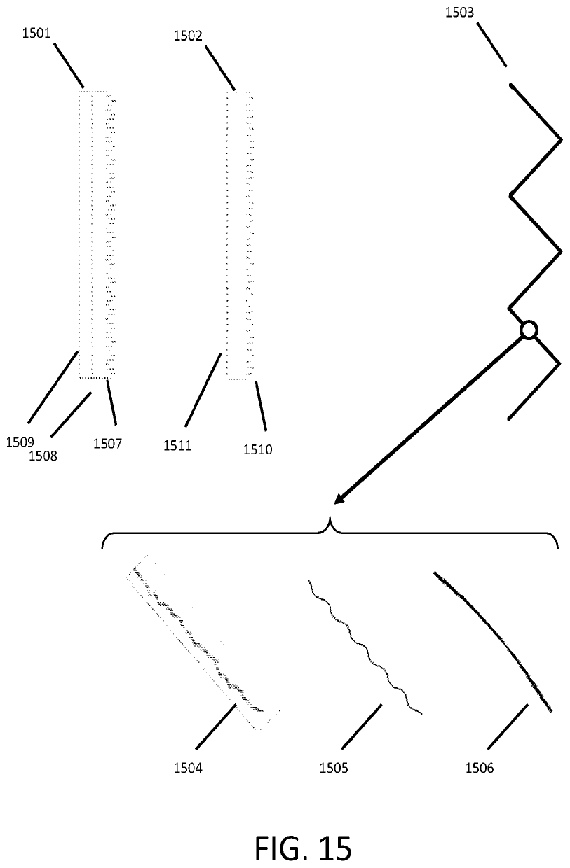

FIG. 15 is a schematic illustration of different methods for optimization of screens comprising retro-reflective optical layers combined with diffuser or light shaping optical modulation layers. 1501 shows a schematic illustration of a retro-reflective layer 1507 combined with a light shaping optical modulation layer 1509. In many cases, the two layers are either attached together using a variety of techniques, including but not limited to double sided adhesive, UV cure adhesive or abutted together with an air gap between the layers. The dashed line 1508 is included to denote that the two optical layers 1507 and 1509 were manufactured separately using two separate substrates. Because the optical layers 1507 and 1509 are typically manufactured using low cost roll-to-roll techniques such as hot embossing, extrusion embossing and cast-and-cure, the cost of the substrate comprises a significant portion of the manufacturing cost. Because of this, a preferred embodiment is to manufacture both the retro-reflective layer 1510 and the light shaping optical modulation layer 1511 at the same time on both sides of a single substrate as shown with 1502. By doing this, not only can cost be reduced, but overall optical stack thickness and weight can be reduced. Another method for more tightly integrating the retro-reflective and light shaping functions is shown in 1503 with a magnified view of illustrative retro-reflective elements. 1504 shows how the surface of a retro-reflective element might be made with slightly angled micro-facets in order to cause spread in the retro-reflected light return profile. 1505 shows how the surface of a retro-reflective element might be made with some engineered surface topology or roughness in order to cause the desired spread in the retro-reflected light return profile. 1506 shows how the surface of a retro-reflective element might be made with an engineered surface curvature in order to cause the desired spread in the retro-reflected light return profile. In addition to 1504, 1505 and 1506, the individual angles for the corner cubes of the RR optical elements may be engineered with angles slightly deviating from 90 degrees in order to cause the desired spread in the retro-reflected light return profile as described in U.S. Pat. No. 9,977,320.

Retroreflective Display Systems Having Retroreflective Displays with Light Profile Modulation Layer

Another aspect of the present disclosure provides a system that is programmed or otherwise configured to implement any of the embodiments described herein. The system can include a computer server that is operatively coupled to a projector and a photo detector. The projector and photo detector can be standalone units or integrated as a projection and detection system.

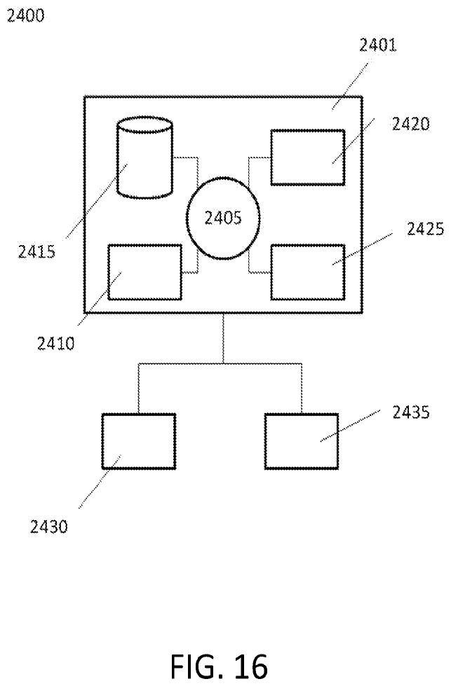

FIG. 16 shows a system 2400 comprising a computer server (“server”) 2401 that is programmed to implement methods disclosed herein. The server 2401 includes a central processing unit (CPU, also “processor” and “computer processor” herein) 2405, which can be a single core or multi core processor, or a plurality of processors for parallel processing. The server 2401 also includes memory 2410 (e.g., random-access memory, read-only memory, flash memory), electronic storage unit 2415 (e.g., hard disk), communication interface 2420 (e.g., network adapter) for communicating with one or more other systems, and peripheral devices 2425, such as cache, other memory, data storage and/or electronic display adapters. The memory 2410, storage unit 2415, interface 2420 and peripheral devices 2425 are in communication with the CPU 2405 through a communication bus (solid lines), such as a motherboard. The storage unit 2415 can be a data storage unit (or data repository) for storing data. The server 2401 can be operatively coupled to a computer network (“network”) with the aid of the communication interface 2420. The network can be the Internet, an internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the server 2401, can implement a peer-to-peer network, which may enable devices coupled to the server 2401 to behave as a client or a server.

The storage unit 2415 can store files or data. The server 2401 can include one or more additional data storage units that are external to the server 2401, such as located on a remote server that is in communication with the server 2401 through an intranet or the Internet.

In some situations, the system 2400 includes a single server 2401. In other situations, the system 2400 includes multiple servers in communication with one another through an intranet and/or the Internet.

The server 2401 can be adapted to store user information and data of or related to a projection environment, such as, for example, display angles and intensity settings. The server 2401 can be programmed to display an image or video through a projector coupled to the server 2401.

Methods as described herein can be implemented by way of machine (or computer processor) executable code (or software) stored on an electronic storage location of the server 2401, such as, for example, on the memory 2410 or electronic storage unit 2415. During use, the code can be executed by the processor 2405. In some cases, the code can be retrieved from the storage unit 2415 and stored on the memory 2410 for ready access by the processor 2405. In some situations, the electronic storage unit 2415 can be precluded, and machine-executable instructions are stored on memory 2410.

The code can be pre-compiled and configured for use with a machine have a processer adapted to execute the code, or can be compiled during runtime. The code can be supplied in a programming language that can be selected to enable the code to execute in a pre-compiled or as-compiled fashion.

The server 2401 is coupled to (e.g., in communication with) a projector 2430 and a photo detector 2435. In an example, the projector 2430 can project an image or video onto a retro-reflective screen. In another example, the projector 2430 can project ultraviolet or infrared light onto the retro-reflective screen. The photo detector 2435 can detect (or measure) reflected light from the retro-reflective screen.

The projector 2430 can include one or more optics for directing and/or focusing an image or video onto the retro-reflective screen. The photo detector can be a device that is configured to generate an electrical current upon exposure to light, such as, for example, a charge-coupled device (CCD). Projectors can include, for example and without limitation, film projectors, cathode ray tube (CRT) projectors, laser projectors, Digital Light Processor (DLP) or Digital Micromirror Device (DMD) projectors, liquid crystal display (LCD) projectors, or liquid crystal on silicon (LCOS) projectors.

Aspects of the systems and methods provided herein, such as the server 2401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables, copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

Methods and systems of the present disclosure can be implemented by way of one or more algorithms. An algorithm can be implemented by way of software upon execution by the central processing unit 2405.

Although the present invention has been described herein with reference to the specific embodiments, these embodiments do not serve to limit the invention and are set forth for illustrative purposes. It will be apparent to those skilled in the art that modifications and improvements can be made without departing from the spirit and scope of the invention.

Such simple modifications and improvements of the various embodiments disclosed herein are within the scope of the disclosed technology, and the specific scope of the disclosed technology will be additionally defined by the appended claims.

In the foregoing, it will be appreciated that any feature of any one of the embodiments can be combined or substituted with any other feature of any other one of the embodiments.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while features are presented in a given arrangement, alternative embodiments may perform similar functionalities with different components and/or sensor topologies, and some features may be deleted, moved, added, subdivided, combined, and/or modified. Each of these features may be implemented in a variety of different ways. Any suitable combination of the elements and acts of the various embodiments described above can be combined to provide further embodiments. The various features and processes described above may be implemented independently of one another, or may be combined in various ways. All possible combinations and subcombinations of features of this disclosure are intended to fall within the scope of this disclosure.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A retroreflective (RR) display configured to display an image by retro-reflectively reflecting incident light from a projector, the RR display comprising:
a retroreflective (RR) layer comprising a plurality of RR elements arranged laterally across a major surface thereof; and
a light profile modulation layer formed over the RR layer, the light profile modulation layer comprising a plurality of light diffusive features formed across a major surface thereof, wherein the light diffusive features comprise micro-facets,
wherein the RR layer and the light profile modulation layer are configured such that light from the projector incident on the light profile modulation layer passes therethrough and is retro-reflected by the RR elements before exiting from the micro-facets of the light profile modulation layer,
wherein the micro-facets of at least a subset of the light diffusive features form angles with corresponding micro-facets of immediately adjacent ones of the light diffusive features along a first lateral axis that are greater than 0.5 degrees, and
wherein the micro-facets have an average area that is substantially smaller than a pixel size of the RR display.

13. The RR display of claim 12, wherein the micro-facets of the at least a subset of the light diffusive features form angles with the corresponding micro-facets of the immediately adjacent ones of the light diffusive features that are substantially the same along a second lateral axis orthogonal to the first lateral axis.

14. The RR display of claim 12, wherein at least another subset of the light diffusive features are randomly oriented.

15. The RR display of claim 12, wherein the micro-facets form angles relative to the major surface of the light profile modulation layer that are not distributed randomly or according to a Gaussian profile.

16. The RR display of claim 12, wherein the light diffusive features comprise an array of micro-facets.

17. The RR display of claim 12, wherein the light diffusive features comprise an array of rectangular micro-facets.

18. (canceled)

19. The display of claim 12, wherein the micro-facets have an average area that is proportional to a pixel size by a ratio of 1:25 or smaller.

20. The RR display of claim 12, wherein an angular distribution of directions of rays of the light exiting from the light profile modulation layer is a non-Gaussian angular distribution relative to a centroid direction of the exiting light rays.

21. The RR display of claim 12, wherein an angular distribution of directions of rays of the light exiting from the light profile modulation layer is such that the intensity of light within range of +/−15 degrees about a centroid direction of the exiting light rays does not vary by more than about 20%.

22. The RR display of claim 12, wherein an angular distribution of directions of rays of the light exiting from the light profile modulation layer comprises a substantially trapezoidal profile.

23. The RR display of claim 12, wherein the micro-facets have a major lateral dimension, and wherein each of the RR elements is configured such that a light ray incident thereon at a RR incident point exits therefrom at a RR exit point, wherein the major lateral dimension of the micro-facets is about the same or smaller than a lateral distance (A) between the RR incident point and the RR exit point.

24. The RR display of claim 12, wherein each of the RR elements is configured such that a light ray incident thereon at a RR incident point exits therefrom at a RR exit point, wherein a lateral distance (A) between the RR incident point and the RR exit point is between 1 μm and 100 μm.

25. The RR display of claim 12, wherein each the micro-facets has a major lateral dimension between about 1 μm and 100 μm.

26. The RR display of claim 12, wherein the RR elements comprise a plurality of bead-shaped RR elements.

27. The RR display of claim 12, wherein the RR elements comprise a plurality of prismatic corner cube-based RR elements.

28. The RR display of claim 12, wherein the light diffusive features have an average lateral feature size (L), and wherein the RR layer and the light profile modulation layer are configured such that a light ray from the projector incident at an incident point on the light profile modulation layer passes therethrough and is retro-reflected by one of the RR elements before exiting at an exit point on the light profile modulation layer, wherein the L is about the same or smaller than a lateral distance between the incident point and the exit point on the light profile modulation layer.

29. A retroreflective (RR) display configured to display an image by retro-reflectively reflecting incident light from a projector, the RR display comprising:
a retroreflective (RR) layer comprising a plurality of RR elements arranged laterally across a major surface thereof; and
a light profile modulation layer formed over the RR layer, the light profile modulation layer comprising a plurality of light diffusive features formed across a major surface thereof, wherein the light diffusive features comprise micro-facets,
wherein the RR layer and the light profile modulation layer are configured such that light from the projector incident on the light profile modulation layer passes therethrough and is retro-reflected by the RR elements before exiting from the micro-facets of the light profile modulation layer,
wherein the micro-facets of at least a subset of the light diffusive features preferentially face a direction that forms an angle greater than 10 degrees relative to one or both of a direction of the light incident on the light profile modulation layer and a direction of the light exiting from the light profile modulation layer, and
wherein the RR display has a viewing window outside of which an intensity of light exiting from the light profile modulation layer falls off by more than 50%, and wherein the direction preferentially faced by the micro-facets of the subset of the light diffusive features are outside of the viewing window.

30. The RR display of claim 29, wherein the micro-facets preferentially face a direction of Fresnel reflection in which at least 1% of light incident on the RR display is directed towards.

31. (canceled)

32. The RR display of claim 29, wherein the light diffusive features comprise an array of micro-facets.

33. The RR display of claim 29, wherein the light diffusive features comprise an array of rectangular micro-facets.

34. The RR display of claim 29, wherein each the micro-facets has a major lateral dimension between about 1 μm and 100 μm.

35. The RR display of claim 29, wherein the RR elements comprise a plurality of bead-shaped RR elements.

36. The RR display of claim 29, wherein the RR elements comprise a plurality of prismatic corner cube-based RR elements.

37. The RR display of claim 29, wherein the light diffusive features have an average lateral feature size (L), and wherein the RR layer and the light profile modulation layer are configured such that a light ray from the projector incident at an incident point on the light profile modulation layer passes therethrough and is retro-reflected by one of the RR elements before exiting at an exit point on the light profile modulation layer, wherein the L is about the same or smaller than a lateral distance between the incident point and the exit point on the light profile modulation layer.
